(19) United States
(12) Patent Application Publication
(10) Pub. No.: US 2008/0123666 A1
(43) Pub. Date: May 29, 2008

(54) Electronic Device And Method Of Communication Resource Allocation

(75) Inventors: Calin Ciordas, Eindhoven (NL); Kees Gerard Willem Goossens, Eindhoven (NL); Andrei Radulescu, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., 5656 AG EINDHOVEN (NL)

(21) Appl. No.: 11/718,979

(22) PCT Filed: Nov. 7, 2005
(86) PCT No.: PCT/IB05/53646

§ 371 Date: Jan. 29, 2008

(30) Foreign Application Priority Data
Nov. 9, 2004 (EP) 04105602.9

(51) Int. Cl. H04L 12/56

(52) U.S. Cl. 370/400

(57) ABSTRACT

Therefore, an electronic device is provided having a plurality of processing modules (IP1-IP5), an interconnect means (N) for coupling the plurality of processing modules (IP1-IP5) enabling at least one first communication (CII) among the processing modules (IP1-IP5), and at least one first module (D1-D5; NI1-N7) for communicating with one of the plurality of processing modules (IP1-IP5) through the interconnect means (N) based on at least one second communication (CI). A second communication (CI) is established which is non-intrusive with regards to the first communication (CII).

The invention relates to an electronic device having a plurality of processing modules and an interconnect means for coupling the plurality of processing modules (IP1-IP5) as well as to a method of communication resource allocation within such an electronic device.

Systems on silicon show a continuous increase in complexity due to the ever increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the systems modules usually communicate to each other via a bus. As the number of modules increases however, this way of communication is no longer practical for the following reasons. On the one hand the large number of modules forms a too high bus load, and the bus constitutes a communication bottleneck as it enables only one device to send data to the bus.

A communication network forms an effective way to overcome these disadvantages. Networks on chip (NoC) have received considerable attention recently as a solution to the interconnect problem in highly-complex chips. The reason is twofold. First, NoCs help resolve the electrical problems in new deep-submicron technologies, as they structure and manage global wires. At the same time they share wires, lowering their number and increasing their utilization. NoCs can also be energy efficient and reliable and are scalable compared to buses. Second, NoCs also decouple computation from communication, which is essential in managing the design of billion-transistor chips. NoCs achieve this decoupling because they are traditionally designed using protocol stacks, which provide well-defined interfaces separating communication service usage from service implementation.

Introducing networks as on-chip interconnects radically changes the communication when compared to direct interconnects, such as buses or switches. This is because of the multi-hop nature of a network, where communication modules are not directly connected, but are remotely separated by one or more network nodes. This is in contrast with the prevalent existing interconnects (i.e., buses) where modules are directly connected. The implications of this change reside in the arbitration (which must change from centralized to distributed), and in the communication properties (e.g., ordering, or flow control), which must be handled either by a intellectual property block (IP) or by the network.

Most of these topics have been already the subject of research in the field of local and wide area networks (computer networks) and as an interconnect for parallel machine interconnect networks. Both are very much related to on-chip networks, and many of the results in those fields are also applicable on chip. However, NoC's premises are different from off-chip networks, and, therefore, most of the network design choices must be reevaluated. On-chip networks have different properties (e.g., tighter link synchronization) and constraints (e.g., higher memory cost) leading to different design choices, which ultimately affect the network services.

NoCs differ from off-chip networks mainly in their constraints and synchronization. Typically, resource constraints are tighter on chip than off chip. Storage (i.e., memory) and computation resources are relatively more expensive, whereas the number of point-to-point links is larger on chip than off chip . Storage is expensive, because general-purpose on-chip memory, such as RAMs, occupy a large area. Having the memory distributed in the network components in relatively small sizes is even worse, as the overhead area in the memory then becomes dominant.

Off-chip networks typically use packet switching and offer best-effort BE services. Contention can occur at each network node, making latency guarantees very hard to offer. Throughput guarantees, i.e. guaranteed-throughput GT, can still be offered using schemes such as rate-based switching or deadline-based packet switching, but with high buffering costs. An alternative to provide such time-related guarantees is to use time-division multiple access (TDMA) circuits, where every circuit is dedicated to a network connection. Circuits provide guarantees at a relatively low memory and computation cost. Network resource utilization is increased when the network architecture allows any left-over guaranteed bandwidth to be used by best-effort BE communication.

A network on chip (NoC) typically consists of a plurality of routers and network interfaces. Routers serve as network nodes and are used to transport data from a source network interface to a destination network interface by routing data on a correct path to the destination on a static basis (i.e., route is predetermined and does not change), or on a dynamic basis (i.e., route can change depending e.g., on the NoC load to avoid hot spots). Routers can also implement time guarantees (e.g., rate-based, deadline-based, or using pipelined circuits in a TDMA fashion). More details on a router architecture can be found in, A router architecture for networks on silicon, by Edwin Rijpkema, Kees Goossens, and Paul Wielage, In PROGRESS, October 2001.

The network interfaces are connected to an IP block (intellectual property), which may represent any kind of data processing unit or also be a memory, bridge, etc. In particular, the network interfaces constitute a communication interface between the IP blocks and the network. The interface is usually compatible with the existing bus interfaces. Accordingly, the network interfaces are designed to handle data sequentialisation (fitting the offered command, flags, address, and data on a fixed-width (e.g., 32 bits) signal group) and packetization (adding the packet headers and trailers needed internally by the network). The network interfaces may also implement packet scheduling, which can include timing guarantees and admission control.

On-chip systems often require timing guarantees for their interconnect communication. Therefore, a class of communication is provided, in which throughput, latency and jitter are guaranteed Connections are used to identify different traffic classes and associate properties to them.

A cost-effective way of providing time-related guarantees (i.e., throughput, latency and jitter) is to use pipelined circuits in a TDMA (Time Division Multiple Access) fashion, which is advantageous as it requires less buffer space compared to rate-based and deadline-based schemes on systems on chip (SoC) which have tight synchronization.

At each slot, a data item is moved from one network component to the next one, i.e. between routers or between a router and a network interface. Therefore, when a slot is reserved at an output port, the next slot must be reserved on the following output port along the path between an master and a slave module, and so on.

When multiple connections with timing guarantees are set up, the slot allocation must be performed such that there are no clashes (i.e., there is no slot allocated to more than one connection). The task of finding an optimum slot allocation for a given network topology i.e. a given number of routers and network interfaces, and a set of connections between IP blocks is a highly computational-intensive problem (NP complete) as it involves finding an optimal solution which requires exhaustive computation time.

It is an object of the invention to provide an electronic device and a method of communication resource allocation with an improved allocation of communication resources.

This object is solved by an electronic device according to claim 1 and a method of communication resource allocation according to claim 7.

Therefore, an electronic device is provided having a plurality of processing modules, an interconnect means for coupling the plurality of processing modules enabling at least one first communication among the processing modules and at least one first module for communicating with one of the plurality of processing modules through the interconnect means based on at least one second communication. A second communication is established which is non-intrusive with regards to the first communication.

Accordingly, the behavior of the first communication is not influenced by the presence or absence of the second communication, i.e. whether or not data is transferred in the second communication.

According to an aspect of the invention dummy data is inserted into the second communication, if no actual data is forwarded to one of the processing units by the first module. Therefore, this dummy data takes the place of the actual data such that the place of the actual data can not be reused by the first communication and the behavior of the first communication is not altered.

According to a further aspect of the invention communication resources are reserved for the second communication to exclude the first communication from reusing the communication resources. Hence, it is prevented that the first communication reuses the communication resource and the behavior of the first communication is not altered without sending additional or dummy data.

According to still a further aspect of the invention the forwarding of dummy data by the at least one first module is deactivated if the second communication resources constitute reserved time slots such that a reuse of unused time slots by the first communication is prohibited.

According to a further aspect of the invention said interconnect means comprise a network, and plurality of network interfaces each being coupled between one of said processing modules and said network. Said network comprises a plurality of routers. The first and second communication are based on connections using connection paths through the network, wherein each of said connection paths employ at least one network link for a required number of time slots. At least one time slot allocating unit is provided for allocating time slots for the first and second communication in order to assign guaranteed communication resources to at least one second communication by marking the time slots associated to the second communication as reserved. Therefore, the principles of the invention can be applied to a network on chip where the communication is performed by time slots.

The invention also relates to a method of communications resource allocation within an electronic device having a plurality of processing modules coupled by an interconnect means enabling at least one first communication among the processing modules. A communication is performed with one of the plurality of processing modules through the interconnect means based on at least one second communication by the first module. A second communication is established which is non-intrusive with regards to the first communication.

Other aspects of the invention are defined in the dependent claims.

The invention is based on the idea to provide a non intrusive communication, i.e. the presence or absence of the communication will not influence the behavior of further communication. This is in particular important for debugging or monitoring applications which should not influence the communication of a system. The non intrusive communication can be provided by inserting dummy data if the actual data is currently not being transferred. Alternatively or additionally the unused communication resources (usually associated to the second communication) can be reserved for an exclusive usage by the second communication.

The invention is now described in more detail with reference to the drawings.

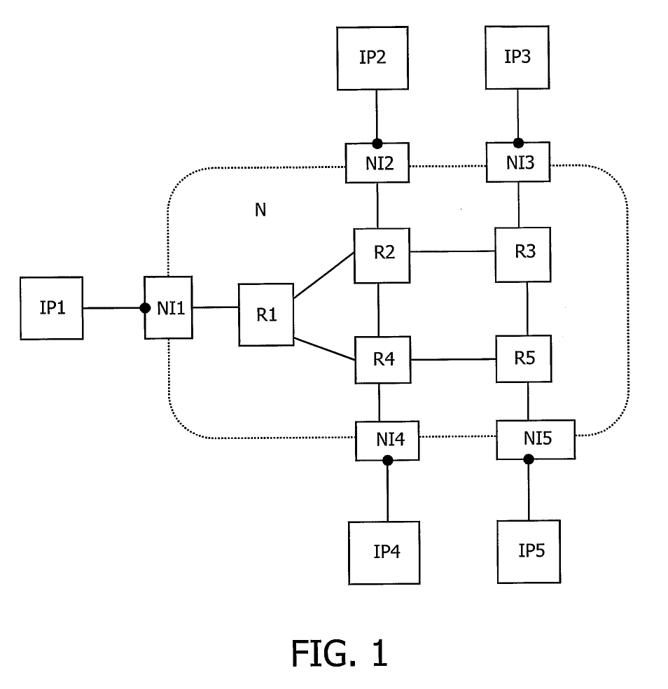

FIG. 1 shows a block diagram of the basic structure of a network on chip according to the invention;

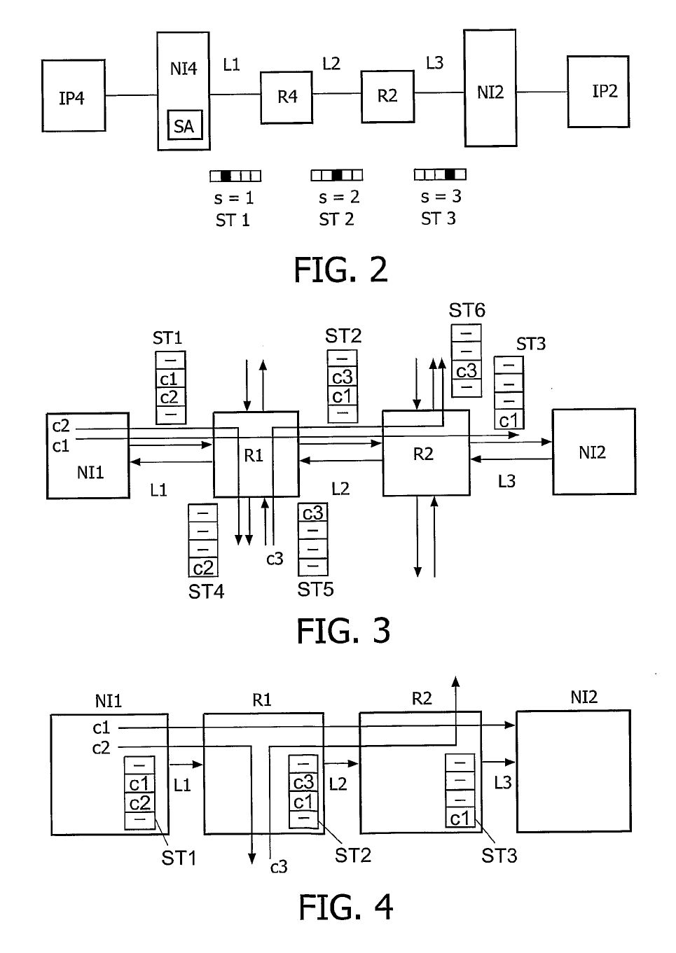

FIG. 2 shows a block diagram of a basic slot allocation for a connection in a network according to FIG. 1;

FIG. 3 shows a block diagram of a slot allocation in more detail in a network according to FIG. 1;

FIG. 4 shows block diagram of a more detailed slot allocation according to a first embodiment;

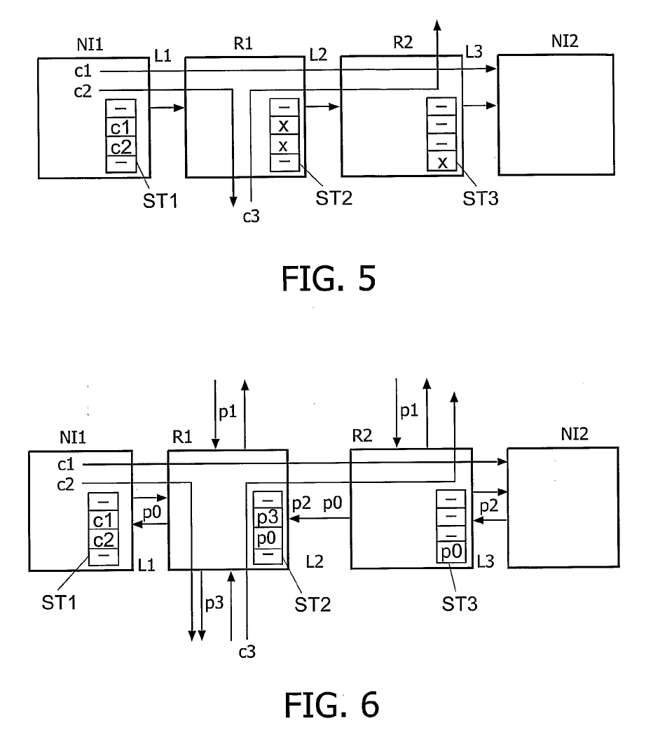

FIG. 5 shows a block diagram of a more detailed slot allocation according to a second embodiment;

FIG. 6 shows a block diagram of a more detailed slot allocation according to a third embodiment;

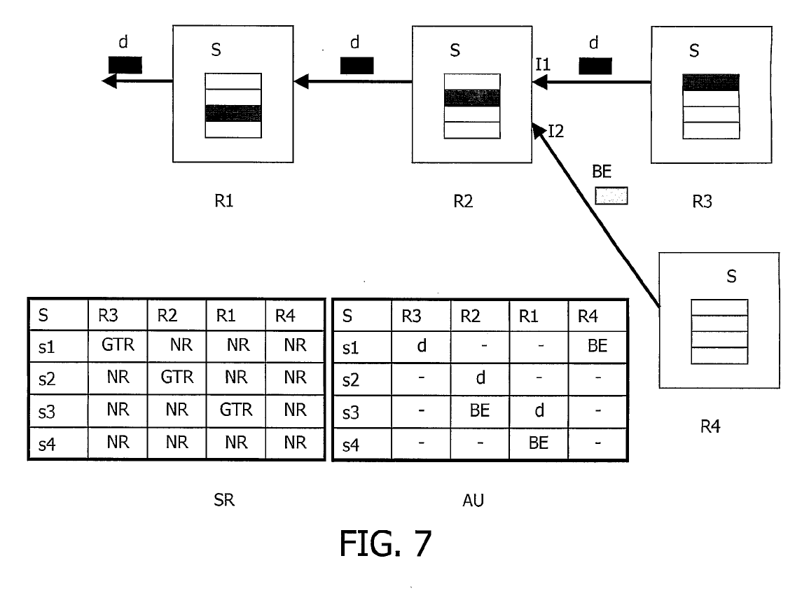

FIGS. 7-10 each show a block diagram of a part of the network N of FIG. 1 with associated slot tables; and

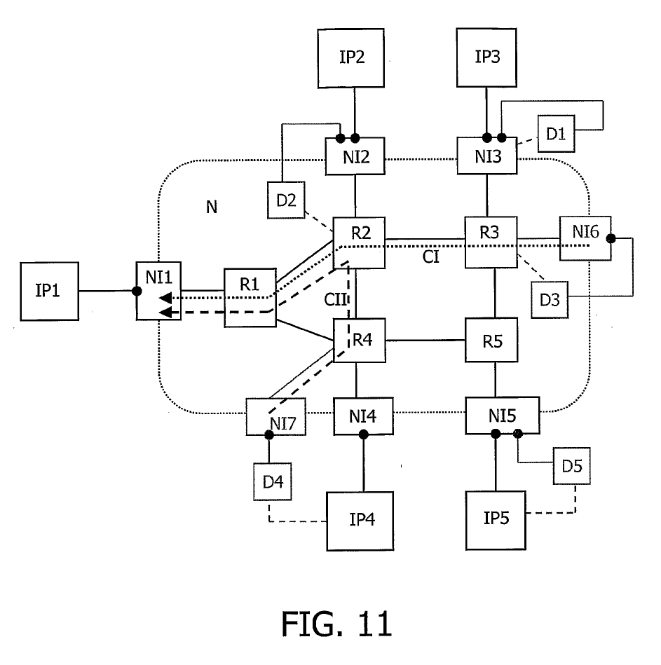

FIG. 11 shows a block diagram of the basic structure of a network on chip according to a third embodiment.

The following embodiments relate to systems on chip, i.e. a plurality of modules on the same die, multiple dies (e.g. system in a package), or on multiple chips communicate with each other via some kind of interconnect. The interconnect is embodied as a network on chip NOC. The network on chip may include wires, bus, time-division multiplexing, switch, and/or routers within a network. At the transport layer of said network, the communication between the modules is performed over connections. A connection is considered as a set of channels, each having a set of connection properties, between a first module and at least one second module. For a connection between a first module and a single second module, the connection may comprises two channels, namely one from the first module to the second module, i.e. the request channel, and a second channel from the second to the first module, i.e. the response channel. Therefore, a connection or the path of the connection through the network, i.e. the connection path comprises at least one channel. In other words, a channel corresponds to the connection path of the connection if only one channel is used. If two channels are used as mentioned above, one channel will provide the connection path e.g. from the master to the slave, while the second channel will provide the connection path from the slave to the master. Accordingly, for a typical connection, the connection path will comprise two channels. The connection properties may include ordering (data transport in order), flow control (a remote buffer is reserved for a connection, and a data producer will be allowed to send data only when it is guaranteed that space is available for the produced data), throughput (a lower bound on throughput is guaranteed), latency (upper bound for latency is guaranteed), the lossiness (dropping of data), transmission termination, transaction completion, data correctness, priority, or data delivery.

FIG. 1 shows a block diagram of a network on chip architecture according to the present invention. The system comprises several so-called intellectual property blocks IPs IP1-IP5 (computation elements, memories or a subsystem which may internally contain interconnect modules) which are each connected to a network N via a network interface NI, respectively. The network N comprises a plurality of routers R1-R5, which are connected to adjacent routers via respective network links.

The network interfaces NI1-NI5 are used as interfaces between the IP blocks IP1-IP5 and the network N. The network interfaces NI1-NI5 are provided to manage the communication of the respective IP blocks IP1-IP5 and the network N, so that the IP blocks IP1-IP5 can perform their dedicated operation without having to deal with the communication with the network N or other IP blocks. The IP blocks IP1-IP5 may act as masters, i.e. initiating a request, or may act as slaves, i.e. receiving a request from a master and processing the request accordingly.

FIG. 2 shows a block diagram of a connection and a basic slot allocation in a network on chip according to FIG. 1. In particular, the connection between the IP block IP4 and IP2 is shown. This connection is realized by a network interface NI4 associated to the IP block IP4, two routers R4, R2, and a network interface NI2 associated to the IP block IP2. The network interface NI4 comprises a time slot allocation unit SA. Alternatively, the network interface NI2, and routers R2 and R4 may also comprise a time slot allocation unit SA. A first link L1 is present between the network interface NI4 and a router R4, a second link L2 is present between the two routers R4, R2, and a third link L3 is present between the router R2 and the network interface NI2. Three slot tables ST1-ST3 for the output ports of the respective network components are also shown. These slot tables are preferably implemented on the output side, i.e. the data producing side, of the network elements like network interfaces and routers. For each requested slot, one slot is reserved in each slot table of the links along the connection path. All these slots must be free, i.e., not reserved by other channels. Since the data advance from one network component to another each slot, starting from slot s=1, the next slot along the connection must be reserved at slot s=2 and then at slot s=3.

The inputs for the slot allocation determination performed by the time slot allocation unit SA are the network topology, like network components, with their interconnection, and the slot table size, and the connection set. For every connection, its paths and its bandwidth, latency, jitter, and/or slot requirements are given. A connection consists of at least two channels or connection paths (a request channel from master to slave, and a response channel from slave to master). Each of these channels is set on an individual path, and may comprise different links having different bandwidth, latency, jitter, and/or slot requirements. To provide time related guarantees, slots must be reserved for the links. Different slots can be reserved for different connections by means of TDMA. Data for a connection is then transferred over consecutive links along the connection in consecutive slots.

FIG. 3 shows a block diagram of an implementation of a connection according to the architecture of FIG. 1. Here, two network interfaces NI1, NM2 and two routers R1, R2 and the three links L1-L3 between the network interface NI1 and the router R1, between the router R1 and the router R2, and between the router R1 and the network interface NI2 are shown, respectively. The IP blocks are not shown. The slot tables ST1-ST3 are shown for each of the labeled link L1-L3. These links are bi-directional, and, hence, for each link there is a slot table for each of the two directions; the slot tables ST1-ST3 are only shown for one direction. Additionally, three connections c1-c3 are depicted. In addition to the above three slot tables ST1-ST3, further slot tables ST4-ST6 are shown. Now all slot tables ST1-ST6 are shown which are related to the three connections cl-c3. The first connection c1 extends from the network interface NI1 to the network interface NI2 via the routers R1 and R2. The second connection c2 extends from the network interface NI1 to the router R1 and then to a further network component (not shown) using slot table ST4. The third connection c3 may originate from a not shown network component and passes from the router R1 to the router R2 and further to another not shown network component using slot table ST6. The connection cl reserves one slot in each of the three links L1-L3 it uses (NI1 to R1, R1 to R2, and R2 to NI2). The slots in these links must be consecutive (slot 2, slot 3, and slot 4, respectively). From a router point of view, in a time slot, the router receives data from input links, on the connection c1-c3 those links L1-L3 are reserved for. The data is stored in the router. At the same time, the router sends the data it has received the previous slot to output links. According to this model, as the data is stored in a router for at most one slot, the slots of a connection must be reserved consecutively.

A possible generalization or alternative of the slot allocation problem would be to allow data to be buffered in the routers for more than one slot duration. As a result, slot allocation becomes more flexible, which could lead to better link utilization, at the expense of more buffering, and potentially longer latencies.

Slots must be reserved such that there are no conflicts on links. This is, there are no two connections that reserve the same slot of the same link. Therefore, C1 reserves slot 2 for the link between Nl1 and R1. Consequently, C2 cannot use slot 2 for the same link.

FIG. 4 shows a block diagram of a straightforward slot table implementation according to a first embodiment by implementing for each of the first, second and third links L1-L3 a table which specifies which slots are reserved for which connection. In particular, only those slot tables ST1-ST3 are shown, which are required by the three connections c1-c3 for the three links L1-L3. A preferred place to store this table is in the router/network interface producing data for that link, i.e. the output port, because the router/network interface has to know, when a link is reserved or not, in order to produce data for that link. It may be possible to only store slot tables in the network interfaces, and omit them from the routers, leading to a cost savings. The table may also be part of the time slot allocation unit SA.

FIG. 5 shows a block diagram of a more efficient slot-allocation encoding according to a second embodiment. Here, also only those slot tables ST1-ST3 are shown, which are required by the three connections c1-c3 for the three links L1-L3. The information to which connection a slot belongs is stored in the network interface NI and in particular in the time slot allocation unit SA, while the slot tables ST1-ST3 in the routers only mark if a slot is reserved or not for the links. The routers need not know the connections associated with slots, as they only moves data from one network element to another and finally to the correct output based on the packet headers (containing a destination address or a path to destination).

In FIG. 6, a block diagram of a possible variation according to a third embodiment to the above encoding of FIG. 4 and FIG. 5 is shown. Here, the routing information is stored in the router itself (instead of the packet header). In output port slot tables ST1-T3, slots indicate from which input data is consumed. In this way, the packet header can be omitted, leading to more throughput, and multicast connections can be supported easily by the network, at the expense of larger slot tables in the routers.

FIG. 7 shows a part of the network N according to FIG. 1, a corresponding slot reservation table SR and a slot table AU showing the actual usage of the slots. Here, four routers R1, R2, R3 and R4 are shown each with a slot table S with four entries S1-S4. According to this embodiment, a debug connection is shown between one or more debug network interfaces DNI and a master network interface MNI and master IP (e.g. a hardware debug IP block such as a transaction validator, or a CPU running debug software), i.e. the network interface where the debug traffic is directed to. Debug connections can also be directed to slave network interfaces and slave IPs (e.g. embedded or off-chip memories). As mentioned above, each connection will reserve a number of slots in consecutive routers R1-R4. The debug connection which is preferably a guaranteed throughput GT connection, travels from router R3 via router R2 to router R1. In the slot tables S of each of the routers R1, R2 and R3 one slot is reserved for this debug traffic d. If more slots are available, these slots may be used by other traffic like a debug traffic from other routers, or normal data traffic. Here, only the debug connection is shown such that all other slots are empty. As the slots are empty, they can be used for a best effort BE connection. The router R4 is related to a best effort connection BE. Accordingly, the router R4 is trying to send a data packet, i.e. a best effort packet, through the routers R2 and R1. However, as the slots reserved in the reservations slot table SR for the debug connection are used by debug packets shown in the example (marked with “d” in the actual usage slot table AU of FIG. 7), the router R4 is not able to send its BE packets to the second router R2.

The slot table SR in FIG. 7 depicts the reservation of slots S1-S4 of the slot table of the routers R1-R4. Basically three different slot reservations can occur, namely a not reserved slot NR, a GT reusable slot GTR, and a GT not reusable slot GTNR. The GTNR slot reservation is not necessary in all schemes described below and may be omitted in some cases for a simpler and/or cheaper implementation, which we may indicate. The slots S1, S2, and S3 of the slot tables of the routers R3, R2, and R1, are all reserved as GT reusable GTR, i.e. they can be reused if not required by the connection. All other slots are reserved as not reserved NR. The slot table AU in FIG. 7 depicts an example of actual usage of the slots S1-S4 of the routers R1-R4, obeying the reservations shown in slot table SR. Here, three different data packets can be allocated to the slots, namely a user BE packet BE, a real debug packet d and a dummy debug packet dd. The dummy packets dd are not necessary in all schemes described below and may be omitted in some cases for a simpler and/or cheaper implementation, which may be indicated. As shown in the slot table AU according to FIG. 7, one slot S1 is used in the router R3 by the debug traffic d. In the following router R2, the slot S2 in the slot table is used by the debug traffic originated from router R3. In the next router R1, the third slot S3 is used by the debug traffic from router R3.

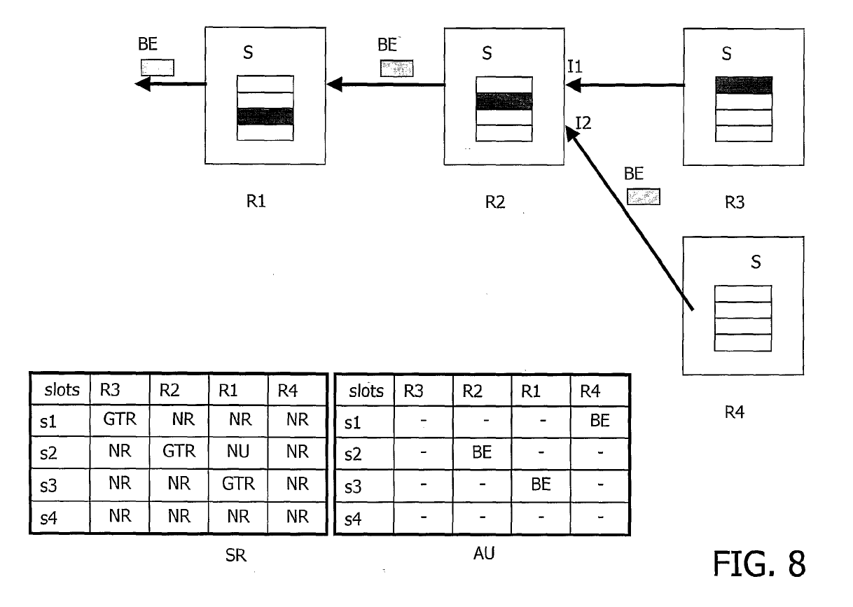

FIG. 8 shows a block diagram of a part of a network of FIG. 1. The structure of the part of the network N according to FIG. 8 corresponds to the structure of the part of the network N according to FIG. 7. The slot reservation table SR depicts the reservation of slots and the slot table AU depicts the actual usage of the slots. However, here there is no real or actual debug traffic present from the third router R3 to the first router R1. Therefore, the slots in the slot table of FIG. 8 previously required for the debug traffic from the third router are now not used (unused) and can be reused e.g. by the best effort user traffic as generated from the fourth router R4. Accordingly, the actual slot usage for this best effort traffic is shown in the slot table AU of FIG. 8, and they are marked with “BE”. If the debug traffic from the router R3 is not present, the overall system will behave differently as in the presence of the debug traffic. However, such a situation is not preferable especially for debug traffic as the debug traffic is especially initiated to find any errors in systems on one or more chips containing a network on, as the current traffic and network on chip components (network interfaces and routers) and IP modules are observed in order to find any errors.

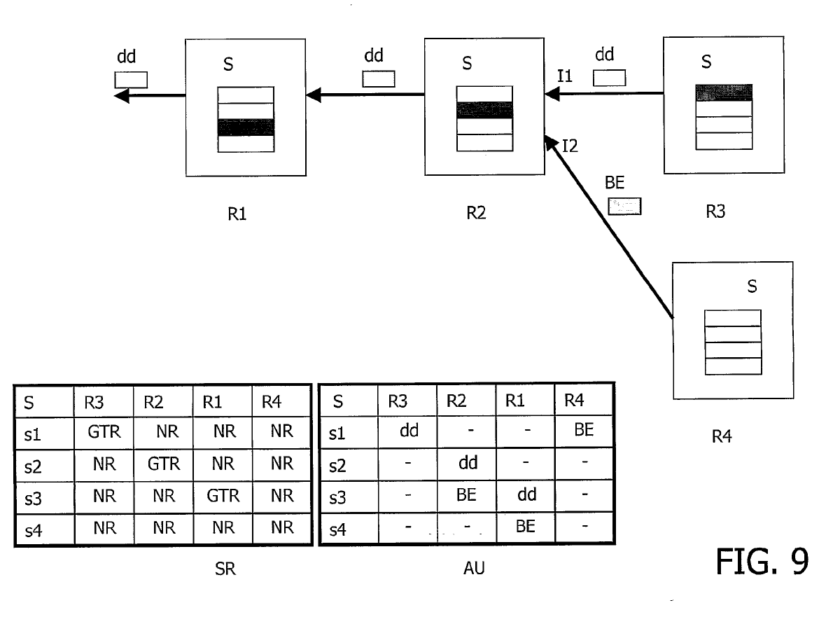

FIG. 9 shows a block diagram of a part of a network of FIG. 1. The block diagram is based on the block diagram of FIG. 8. Here, dummy packets are being introduced to fill the unused time slots. The slot allocation is performed such that at least some kind of debug traffic is always present. As the connection between R3, R2 and R1 is marked as GR reusable GTR, dummy packets dd are sent instead of real debug data packets in order use the reserved slots in the slot table SR and to maintain the debug traffic as non-intrusive with regard to the remaining traffic in the network on chip NOC. The dummy data can be inserted by a debug module or be a network interface.

Here, as the debug connection does not contain real debug data (d) but contains dummy packets instead, between the router R1, R2 and R3, the slots in the slot table AU previously used by such a debug connection are now marked with “dd”. Accordingly, the first slot S1 in the slot table AU of R3, the second slot S2 in the slot table AU of the second router R2 and the third slot S3 in the slot table AU of the first router R1 are marked with “dd”, respectively, corresponding to dummy debug packets (dd) that are sent instead of real debug packets (d) or no debug packets at all . Therefore, any best effort BE traffic from the fourth router R4 can only be incorporated in first slot S1 of R4, the third slot S3 in the slot table of the second router R2 and in the fourth slot S4 in the slot table of the first router R1. Hence, there is no observable difference in the behavior of user data between the situations described in FIG. 7, where real debug traffic is present, and FIG. 9, where dummy debug traffic is present.

A debug connection may contain actual debug data or may contain dummy debug data. The presence of the dummy packets is to ensure that any best effort connections have the same behavior with or without the actual real debug traffic, such that the actual performance and function of the network on chip environment can be observed and analyzed. Note that when dummy debug packets are sent, the GTNR (GT non reusable slot) slot table marking may be omitted, because the objective of non-intrusive debug has been achieved.

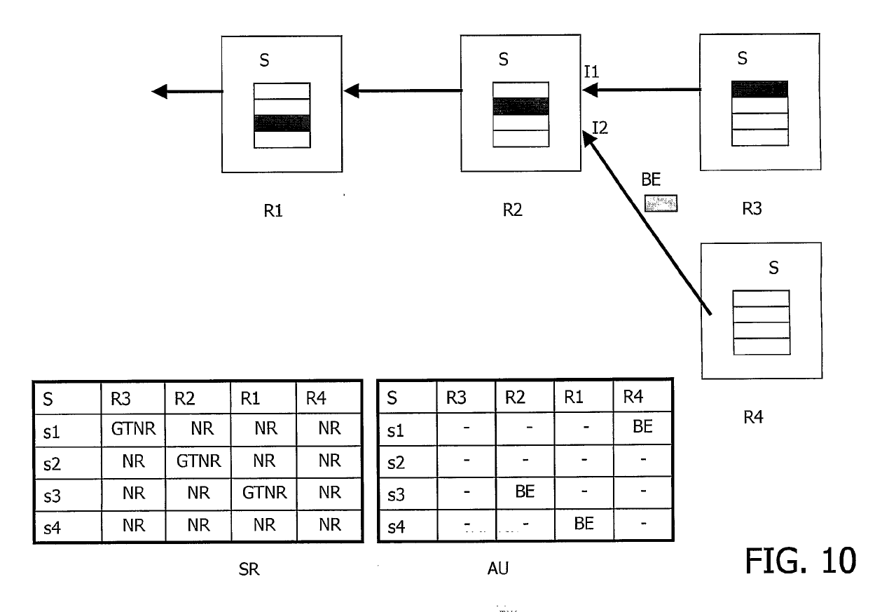

FIG. 10 shows a block diagram of a part of a network of FIG. 1. In contrast to the embodiments of FIGS. 7-9, the debug connection is marked as GT not reusable GTNR, i.e. the slots S1-S3 are marked GTNR in the slot tables SR of the router R3, R2 and R1, respectively. As these slots are not to be reused, if no debug traffic is present, best effort traffic must wait for the next slot. As shown in the actual usage slot table AU, no information is sent in slots S1-S3 corresponding to slots marked GTNR in slot table SR, and the best effort traffic is sent in the subsequent slot. The result is identical to the embodiment shown in FIG. 8. In this case, because slot reservations of type GTNR are used, no dummy packets have to be sent.

The usage of an additional marker indicates that a particular slot is associated to a guaranteed throughput connection that cannot be reused. This is in particular advantageous as such an additional marker can be used to reduce the switching of the data lines of the router and keep the data lines constant instead of sending any dummy packets. A reduced switching activity will also lead to a reduced power dissipation.

However, additional bits have to be incorporated into the slot table if the additional marker does not fit to the already present word. A N-router will need e.g. (2 log N)+1 or 2log(N+1) bits instead of 2 log N bits, depending on the encoding used.

Although the above described embodiments related to debug traffic, the principle of the invention is not limited to debug traffic that may include any non-intrusive traffic such as monitoring for debugging, monitoring for performance analysis, resource management, network management or the transport of functional data.

A non-intrusive traffic can be achieved by sending dummy data to reserve a guaranteed capacity or to mark the reserved capacity as not being reusable by normal traffic.

FIG. 11 shows a block diagram of a network on chip according to a third embodiment. The architecture of the network on chip according to FIG. 11 substantially corresponds to the architecture of FIG. 1. Accordingly, 5 IP blocks IP1-IP5 each with an associated network interface NI1-NI4 are shown. The network N comprises 5 routers R1-R5. In addition, several debug modules D1-D5 are depicted. These debug modules D1-D5 may be arranged inside or outside of the network N. Furthermore, additional network interfaces NI6 and NI7 are also present. The purpose of the debug modules is to collect debug information (such as packets, sampling of programmable registers, events and interrupts from hardware and software) from a variety of possible sources (network components such as routers and network interfaces and network links, as well as IP modules). The dashed lines in FIG. 11 give examples of where the shown debug modules obtain their debug information from. For example, the debug modules D4 and D5 obtain their information from IP block IP4 and IP5, respectively. The debug module D2 and D3 obtain their debug information from routers D2 and D3, respectively. The debug module D1 obtains its debug information from network interface NI3. Furthermore, a debug module can send the debug information it obtained (as described above) using a debug connection. The debug connection can be implemented by a NI shared with other IP or debug modules (NI). Examples of NIs dedicated to a debug module are NI6 and NI7, and examples of NMs shared with other IP blocks are NI2, NI3, NI5. It may be advantageous to share NMs with IP blocks because when debug connections are not used they can be used as normal functional connections. The debug modules can be implemented in hardware (HDM) or in software (SDM).

In particular, two connections CI, CII are shown in FIG. 12. The first connection CI corresponds to the debug connection and the second connection CII corresponds to the BE connection.

The present invention is directed to a monitoring and debug problem within networks on chips. Any monitoring/debugging traffic should be non-intrusive. The scope of the invention is however directed to any interconnect, including busses, switches, networks on a single die, multiple dies (system in a package), and multiple chips. This can be performed by using a NOC (or any interconnect) without guarantees, and either always send debug information or dummy information (this will depend on having deterministic arbitration etc., i.e. the dummy debug packets must be the same as real debug packets for e.g. arbiters). Furthermore, a NOC (or any interconnect) can be used with guarantees (e.g. guaranteed throughput, however also other guarantees are possible) without allowing to reuse unused GT capacity (e.g. slots) by BE traffic (e.g. by having unreserved slots NR, reserved and reusable slots GTR, and reserved and not reusable slots GTNR). Moreover, a NOC (or any interconnect) can be used with guarantees allowing the reuse of unused GT capacity (e.g. slots) by BE traffic, and either always send debug information or dummy debug information. Combinations of the above are also possible.

The above described principles of the invention can be supported by existing network on chip architectures and infrastructures such that no extra hardware will be required in the particular routers and network interfaces of the network on chip. If an influence on the system behavior is acceptable, the reserved bandwidth for the debug connection for the non-intrusive connection can be reused for other best efforts or guarantee throughput connections.

The above described time slot allocation can be applied to any data processing device comprising several separated integrated circuits or multi-chip networks, not only to a network on a single chip.

An electronic device is provided which comprises a plurality of processing modules (IP1-IP5), an interconnect means (N) for coupling the plurality of processing modules (IP1 -IP5) enabling at least one first communication among the processing modules (IP1-IP5), at least one first module (D1-D5) for communicating with one of the plurality of processing modules (IP1-IP5) through the interconnect means (N) based on at least one second communication; at least one time slot allocating unit (SA) allocating time slots for the first and second communication to communicate over the interconnect means (N) in order to assign guaranteed communication properties to at least one second communication. The first module (D1-D5) is adapted to forward dummy data if no actual data is to be communicated to one of the plurality of processing modules (IP1-IP5).

Furthermore, the forwarding of dummy data by the at least one first module (D1-D5) is deactivated if the guaranteed communication properties forbid a reuse of unused time slots.

Although in the above embodiments a network on chip has been described as interconnect, the principles of the invention can also be applied to other interconnects like a bus or switches. Furthermore, although in the above embodiments a communication has been described based on time-division multiple access (TDMA) also other communications are possible like a rate based communication or other possibilities to divide the available bandwidth between the respective communications or connections.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Electronic device, comprising:
a plurality of processing modules;
an interconnect means for coupling the plurality of processing modules enabling at least one first communication among the processing modules;
at least one first module for communicating with one of the plurality of processing modules through the interconnect means based on at least one second communication;
wherein a second communication is established which is non-intrusive with regards to the first communication;

2. Electronic device according to claim 1, wherein
dummy data is inserted into the second communication, if no actual data is forwarded to one of the processing units by the first module.

3. Electronic device according to claim 1, wherein
communication resources are reserved for the second communication to exclude the first communication from reusing the communication resources.

4. Electronic device according to claim 1, wherein
the forwarding of dummy data by the at least one first module is deactivated if the second communication resources constitute reserved time slots such that a reuse of unused time slots by the first communication is prohibited.

5. Electronic device according to claim 1, wherein
said interconnect means comprise a network;
a plurality of network interfaces each being coupled between one of said processing modules and said network;
wherein said network comprises a plurality of routers
wherein the first and second communication are based on connections using connection paths through the network, wherein each of said connection paths employ at least one network link for a required number of time slots;
at least one time slot allocating unit is provided for allocating time slots for the first and second communication in order to assign guaranteed communication resources to at least one second communication by marking the time slots associated to the second communication as reserved.

6. Data processing system comprising at least one electronic device according to claim 1.

7. Method of communication resource allocation within an electronic device having a plurality of processing modules coupled by an interconnect means enabling at least one first communication among the processing modules, comprising the steps of:
communicating with one of the plurality of processing modules through the interconnect means based on at least one second communication by the first module;
wherein a second communication is established which is non-intrusive with regards to the first communication.

8. Method according to claim 7, wherein
dummy data is inserted into the second communication, if no actual data is forwarded to one of the processing units by the first module.

9. Method according to 7, wherein communication resources are reserved for the second communication to exclude the first communication from reusing the communication resources.

10. Method according to claim 7, wherein
the forwarding of dummy data by the at least one first module is deactivated if the second communication resources constitute reserved time slots such that a reuse of unused time slots by the first communication is prohibited.
